(19) United States
(12) Patent Application Publication
(10) Pub. No.: US 2010/0126646 A1
(43) Pub. Date: May 27, 2010

(54) METHOD AND APPARATUS FOR PRODUCING TIRE INNER LINER MEMBERS, AND TIRE HAVING INNER LINER

(75) Inventors: Shigeo Kudo, Osaka (JP); Tetsuo Tatara, Osaka (JP); Osamu Fujiki, Osaka (JP)

Correspondence Address: FISH & RICHARDSON P.C., P.O. BOX 1022, MINNEAPOLIS, MN, 55440-1022, US

(73) Assignee: Toyo Tire & Rubber Co., Ltd., Osaka (JP)

(21) Appl. No.: 11/996,637

(22) PCT Filed: Jul. 28, 2005
(86) PCT No.: PCT/JP2005/013870

§ 371 Date: Mar. 10, 2008

(51) Int. Cl. B60C 5/00; B29D 30/08

(52) U.S. Cl. 152/450; 156/117; 156/397

(57) ABSTRACT

A process for producing easily in high efficiency an inner liner having strip pieces obtained by cutting a ribbonlike rubber strip at given length arranged in parallel relationship in the across-the-width direction, aligned in the direction of tire circumference and bonded together. The process comprises spirally winding ribbonlike rubber strip (21) round liner forming drum (10) at given pitch so as to make partial superimposition, thereby obtaining tubular matter (20), and cutting the tubular matter (20) at one position on the circumference thereof in the across-the-width direction so as to provide a sheet wherein severed strip pieces (21A) are bonded to each other in the state of being aligned in parallel relationship, having a length corresponding to the length of liner circumference on a forming drum in the tire forming step, and wherein the two ends on the starting side and terminating side of the spirally winding can be joined together on the forming drum.

### TECHNICAL FIELD

The present invention relates to a method and apparatus for producing tire inner liner members, and a tire having an inner liner.

### BACKGROUND ART

In general, tires are made up of a plurality of tire constituent members. For example, as is shown in FIG. 10, an inner liner 2, a tread 3, side walls 4, rim strips 5 and the like are formed of rubber members which are prepared according to properties required therefor, respectively, and these rubber members are combined with tire reinforcement members such as carcass layers 6 and belt layers 7 which include cords so as to make up a tire T. In the figure, reference numeral 8 denotes a bead portion which includes a bead core 9.

Conventionally, to built the respective rubber members, rubber members were extruded via dies which match cross-sectional shapes of the rubber members, and thereafter, the extruded rubber members were cut to predetermined dimensions so as to obtain target rubber members. In building a tire, the rubber members were sequentially affixed together on a building drum for building. For example, as regards the inner liner, a length of sheet of a predetermined width was cut to a predetermined dimension and was wound round a cylindrical building drum, and both end portions thereof were joined together in one location in a circumferential direction.

In recent years, accuracies with respect to tire configurations are getting severer, and from the viewpoint of tire balance, uniformity and the like which result from the respective rubber members being joined in one location in the circumferential direction, as is shown in Patent Document No. 1 or 2 below, an approach has been put into practice for rubber members such as the inner liner in which an unvulcanized rubber strip which is extruded into a ribbon shape is spirally wound in an overlapping fashion along a circumferential direction of a tire on a building drum to realize a predetermined cross-sectional shape.

In addition, as is seen in Patent Document Nos. 3 and 4 below, for example, as regards the inner liner, an approach is also proposed in which the ribbon-shaped rubber strip is cut to a constant length, and strip pieces so cut are aligned parallel on a conveyor or an expandable drum for joining, so as to be built into an inner liner in which the strip pieces are aligned while being oriented in a radial direction of the tire.

In the event, however, that the inner liner, which constitutes an innermost layer, is built by winding spirally a ribbon-shaped rubber strip on the expandable drum as described in Patent Document No. 1, oblique unnecessary portions are produced at an end portion on a winding initiating side and an end portion on a winding terminating side, and work to cut these unnecessary portion is necessary.

In addition, in the case of spiral winding, since single-layer portions are produced at both end portions on a winding initiating side and a winding terminating side, in order to secure a thickness required for the inner liner at both the end portions, it is practiced that the number of times of winding is increased at the winding initiating side and winding terminating side end portions of the rubber strip or the winding width is increased, so as to cut off both the end portions. In this case, the unnecessary portions at both the end portions need to be cut off, and moreover, the amount of rubber strip used is uneconomically increased.

The problem with the thickness of the end portions on the winding initiating side and winding terminating side is also caused similarly even in the case of an initial winding on the winding initiating side and a final winding on the winding terminating side being performed without inclining the rubber strip, which is basically wound spirally, in the circumferential direction of the tire as described in Patent Document No. 2.

Furthermore, in the event that the inner liner is produced through spiral winding on the building drum and is then built, the direction in which the rubber strip is spirally wound and the direction in which ply cords extend in a carcass layer which is laminated thereon (basically, a radial direction) come to intersect, whereby irregularities caused by the ply cords and portions where a difference in level is caused by an overlap of the spirally wound rubber strip cross each other, and recessed portions or gaps are produced therebetween and thereby air reservoirs are formed in the portions where the recesses or gaps are so produced, leading to a fear that a building failure or production failure is caused.

In addition, since joining portions where the rubber strip is joined to itself as a result of the rubber strip being overlapped on itself while being wound spirally exist continuously in the circumferential direction of the tire, there is a fear that the joined portions are disjoined when expanded in the building process to thereby produce non-bonded portions, which is not preferable from the viewpoint of durability performance of the tire. Furthermore, the winding initiating side end portion and the winding terminating side end portion come to be situated underneath the bead portions, thereby causing a fear that the tire balance accuracy is deteriorated.

In addition, as in the case with Patent Document Nos. 3 and 4, in the case of the inner liner being produced in which the cut strip pieces are aligned in the circumferential direction of the tire with each oriented in the radial direction of the tire, since the circumferential length of the building drum is according to the size of a tire, in order to align strip pieces which are cut to a constant length at equal pitch, a setting is necessary such that the circumferential length becomes a multiple of an integer, whereby flexibility is restricted remarkably, compared to the case where the spiral winding is adopted. In addition, the expanding and contracting structure of the building drum needs to be considered in order for the strip pieces to be aligned while being oriented in the radial direction of the tire.

In particular, in the event that the strip pieces are aligned on the expandable building drum for joining, since the building drum has gaps between drum pieces for allowing for the expansion and contraction of the building drum, the strip pieces cannot be bonded together completely in the portions where the gaps are provided, and as a result, there is caused a fear that a production failure is produced such as separation, air mixing or the like.

### Patent Document No. 1: JP-A-9-29858

### Patent Document No. 2: JP-A-2002-178415

### Patent Document No. 3: JP-A-2004-175157

### Patent Document No. 4: JP-A-2004-174765

### DISCLOSURE OF THE INVENTION

### Problem that the Invention is to Solve

The invention has been made with a view to solving the problems described above and in particular to provide a method and apparatus for producing inner liner members which can produce with ease and good efficiency an inner liner member in which strip pieces which are cut to a predetermined length are aligned and joined together in a circumferential direction of a tire while being oriented in a radial direction of the tire without causing the problems described, and a tire which utilizes an inner liner obtained by the method and apparatus.

### Means for Solving the Problem

The invention is characterized by a tire inner liner member producing method including spirally winding a ribbon-shaped rubber strip round a liner forming drum at constant pitch in such a manner as to allow the rubber strip to partially overlap itself so as to be formed into a cylindrical body, and cutting the cylindrical body in a width direction which is parallel to a drum axial center in one location in a circumferential direction thereof, to thereby form the cylindrical body into the shape of a sheet in which strip pieces so cut are joined together in such a state that the strip pieces are aligned parallel to thereby give the cylindrical body a length corresponding to a liner circumferential length and in which both an end portion on a winding initiating side and an end portion on a winding terminating side of the spiral winding can be joined together on a building drum in a tire building process.

By this configuration, it is ensured that the cut strip pieces can be joined together on the liner forming drum, and due to this, no bonding failure occurs and there is caused no fear that separation is generated even when the drum is expanded in the tire building process. In addition, since the winding initiating side end portion and the winding terminating side end portion of the spiral winding can be joined together while being superposed on each other on the building drum, no unnecessary portion is produced in the winding initiating side end portion and the winding terminating side end portion in building, whereby the cutting treatment of the end portions which occurs when the rubber strip is wound spirally directly round the expandable building drum in the tire building process can be made unnecessary, thereby making it possible to suppress the waste of the rubber material.

In the inner liner member producing method, the cylindrical body formed by spirally winding the rubber strip is formed such that a circumferential length thereof corresponds to a lateral width of an inner liner member on the building drum and an axial length thereof corresponds to a length which results by adding joint margins to the liner circumferential length on the building drum and the cylindrical body so formed is then cut in the width direction which is parallel to the drum axial center so as to be formed into the shape of a sheet.

By this configuration, only by performing the cutting in the one location after the spiral winding has been completed, the sheet-shaped inner liner member which can be affixed to the building drum in the tire building process can be produced, and both the winding initiating side and winding terminating side end portions of the spiral winding can be superposed on each other as joint margins so as to be joined together. In particular, since the superposing amount of both the end portions which constitute the joint margins in joining them together on the building drum can be adjusted, the width of the rubber strip and the pitch of the spiral winding can be set as required, and thereby flexibility according to tire sizes can be secured.

In the inner liner member producing method, it is preferable that the rubber strip is wound spirally into the cylindrical body in such a manner that a winding initiating end and a winding terminating end of the rubber strip are aligned in positions on a line in the width direction which is parallel to the drum axial center and the cylindrical body is cut on the line which connects the winding initiating end and the winding terminating end. By this configuration, both the end portions can be joined together substantially uniformly over the whole width.

In the inner liner member producing method, the ribbon-shaped rubber strip is wound spirally in such a manner as to be overlapped on itself one half or more of a strip width, so that the rubber strip is wound in two or more layers except for both the winding initiating side end portion and the winding terminating side end portion thereof. As this occurs, the inner liner member can be formed in two or more layers as a whole through the single spiral winding except for the winding initiating side and winding terminating side end portions, and moreover, since the inner liner member can be made to be made up of two or more layers also at both the end portions by superposing them on each other for joining, a joint can be made where the two or more layers are secured without increasing excessively the number of times of winding.

In addition, the invention is characterized by a tire inner liner member producing apparatus including a liner forming drum which is a cylindrical drum which has an axial length which is longer than a tire circumferential length of an inner liner member that is to be produced and a circumferential length which corresponds to a lateral width of the inner liner member and in which a cutting slit which is longer than the tire circumferential length of the inner liner member is formed in one location in a circumferential direction thereof and a severing cutter whose edge is adapted to enter the slit in the drum, so that a cylindrical body made up of a rubber strip which is wound spirally round the drum can be cut along the slit.

The method described above can easily be implemented by using the apparatus described above, whereby the rubber strip spirally wound round the liner forming drum can be joined to itself by allowing the rubber strip to be overlapped substantially uniformly over the whole length thereof in an ensured fashion, and moreover, after the spiral winding, the cylindrical body so formed can be cut in the location where the slit is formed. Furthermore, in the apparatus, in the case of the supporting table being separately provided on which the sheet-shaped member which results after the spirally wound cylindrical body has been cut can be placed in a deployed state, by placing the sheet-shaped member which results from the cutting described above thereon in the deployed state, the sheet-shaped member can be shaped into a normal sheet shape, and is turned to change its vertical and horizontal directions so as to be affixed to the building drum with its cut edges oriented in the tire circumferential direction for ease of the building.

In addition, the invention is characterized by a tire having an inner liner in an innermost layer in which a sheet-shaped inner liner member, which is obtained by a producing method as set forth in any of Claims 1 to 4 and in which a large number of cut strip pieces are aligned to be joined in parallel with each other as a result of a cylindrical body made up of a ribbon-shaped rubber strip which is wound spirally in such a manner as to be partially overlapped on itself being cut in a width direction which is parallel to a drum axial center in one location in a circumferential direction thereof, is joined together at winding initiating side and winding terminating side end portions of the spiral winding where the rubber strip is superposed in two or more layers.

In the tire which is built in the way described above, since the inner liner is such that the large number of strip pieces are joined together while aligned in such a manner as to be overlapped on one another at the constant pitch and the end portions are superposed on each other in two or more layers for joining at the joint portion, a good weight balance is imparted to the tire, the uniformity of the tire is deteriorated in no case, and a separation or the like is produced in no case.

In the tire described above, the strip pieces which make up the inner liner are aligned in the same direction as that in which ply cords are aligned in a carcass layer which is laminated thereon.

By this configuration, since the strip pieces which make up the inner liner member are aligned substantially in the same direction as that of mainly the ply cords which are aligned in the radial direction in the carcass layer which is laminated thereof, the direction of the strip pieces becomes identical relative to the elongation of the tire in the radial direction thereof and the divergence of the cords in the circumferential direction, whereby the quality of the tire is held properly. In addition, since portions where a difference in level is caused by the overlap of the strip pieces and irregularities caused by the ply cords does not cross each other, no air reservoir is produced, thereby making it possible to suppress the generation of a building failure and product failure.

### BEST MODE FOR CARRYING OUT THE INVENTION

Next, a mode for carrying out the invention will be described based on an embodiment shown in drawings.

FIGS. 1 and 2 show schematically a liner forming drum 10 and a severing cutter 15 which are main members of a producing apparatus which is used in implementing an inner liner member producing method of the invention.

The liner forming drum 10 which is used in the invention is made up of a cylindrical drum in which its axial length L1 is longer than a circumferential length of an inner liner member which is to be produced on a building drum in a tire building process and its circumferential length corresponds to a lateral width of the inner liner member on the building drum and which is a normal drum which is neither expanded nor contracted. A cutting slit 12, which is slightly longer than the circumferential length L2 of the inner liner member to be produced and is slightly shorter than the axial length L1 of the drum 10, is formed in the drum 10 in a location in a circumferential direction thereof in such a manner as to extend in a width direction which is parallel to a drum axial center.

The slit 12 is such as to function as a guide when an edge portion of the severing cutter 15 enters the drum 10, and the slit 12 does not have to penetrate through an interior of the drum 10 as is shown in the figure and can be formed into a groove shape which does not penetrate therethrough. Reference numeral 13 in the figure denotes a rotational support shaft of the drum 10 and 14 denotes a boss portion, and a cylindrical drum main body 10a is desirably made to be connected to the boss portion 14 in such a manner as to be replaced in response to a change in size of inner liner members to be produced.

Although a relatively light and inexpensive metal material such as aluminum is preferably used as a material for the drum 10 due to an easy replacement being enabled thereby when sizes are changed, the drum 10 can be formed by the use of other metal materials.

In addition, the cutter 15 may take any form such as a rotary blade or a sliding blade, provided it is such as to cut a cylindrical body 20 which is made up of a rubber strip 21 which is spirally wound round the drum 10 in the location where the slit 12 is formed.

A producing apparatus which is made up by a combination of the drum 10 and the cutter 15 can be placed in the vicinity of a building position where an inner liner is built during a tire building process or can be placed separately from the tire building process. In either of the cases, as is shown in FIG. 3, it is desirable to provide a supporting table 16 to which a sheet-shaped member which is obtained by cutting a formed cylindrical body on the drum 10 can be sent out in a deployed state. Reference numeral 17 in the figure denotes an extruding machine for continuously extruding the unvulcanized rubber strip 21 which forms an inner liner member into a ribbon shape.

Next, a method for producing an inner liner member using the apparatus will be described based on the drawings.

For example, a cylindrical body 20 of a predetermined length, which will be described later, is formed by supplying a ribbon-shaped rubber strip 21 which is extruded in a predetermined thickness of preferably 0.5 to 3.0 mm and a predetermined width of preferably 5.0 to 50 mm by the extruding machine 17 in FIG. 3 to the liner forming drum 10 so as to be spirally wound round on a circumferential surface of the drum 10 within a length L2 of the slit 12 as shown in the figure in such a manner that the rubber strip 21 partially overlaps itself at pitch of a constant distance which is smaller than a width of the rubber strip. The rubber strip 21 is wound spirally in such a manner that a winding initiating end 21a and a winding terminating end 21b of the rubber strip 21 are preferably aligned in positions on the same line in a width direction on the outer circumferential surface of the drum 10 and are particularly preferably aligned in the position where the slit 12 is formed, as is shown in FIG. 4. Namely, the rubber strip 21 is wound in such a manner that the winding starts from the location where the slit 12 is formed and terminates at the location where the slit 12 is formed.

In addition, although a pitch of the spiral winding of the rubber strip 21 can be set as required according to a strip width W1, for example, in the event that the rubber strip 21 is wound spirally in two or more layers overall, the rubber strip 21 is spirally wound at pitch of ½ or smaller of the strip width W1 in such a manner that the rubber strip 21 is made to overlap itself ½ or more of the strip width W1. In addition, the tubular body 20 is formed in such a manner that an axial length L3 thereof corresponds to a length which results by adding joint margins made up of a winding initiating side end portion 22 and a winding terminating side end portion 23 to the liner circumferential length on the building drum in the tire building process. The joint margins at both the end portions 22, 23 are set to each include a portion where the rubber strip 21 is wound round at least a single circumferential rotation in one layer.

After the spiral winding has been completed in the way described above, the cylindrical body 20 is cut in the width direction which is parallel to the drum axial center by the cutter 15 in the location of the slit 12 which is situated in the one location in the circumferential direction thereof. By this, when the winding initiating end 21a and the winding terminating end 21b are situated in the location of the slit 12, the tubular body 20 is cut on a line which connects the winding initiating end 21a with the winding terminating end 21b.

In addition, after the cylindrical body 20 has been so cut, the resulting sheet-shaped member is placed on the table 16 in a deployed state, whereby the curling of the sheet-shaped member is smoothed and the sheet-shaped member is shaped into the normal sheet shape.

As is shown in FIG. 6, the sheet-shaped member that is produced in the way that has been described above is formed into a sheet-shaped inner liner member 20A which is formed into a sheet shape in which cut strip pieces 21a are aligned parallel in the same direction and are joined together while being overlapped on each other by an amount which corresponds to the pitch of the spiral winding and which has a length corresponding the axial length L3 of the tubular body 20, that is, the length which results by adding the joint margins to the circumferential length on the building drum in the direction in which the strip pieces are aligned and in a direction which intersects this direction, that is, a longitudinal direction of the strip pieces 21A a width which is the circumferential length of the drum 10.

The inner liner member 20A that is produced in the way that has been described above is such as to be used as an inner liner for, for example, a tire illustrated in FIG. 10, and as this occurs, the inner liner member 20A is used in such a manner that the vertical and horizontal directions thereof are turned through 90° so that the direction in which the strip pieces 21A are aligned (the axial direction on the drum 10), that is, the direction of the cut edge is changed to the tire circumferential direction on the building drum and the longitudinal direction of the strip pieces 21A is changed to the radial direction of the tire. In reality, the strip pieces 21A are slightly inclined relative to the radial direction as a result of the spiral winding. In addition, the strip pieces 21A are aligned in the drum width direction to be affixed to the building drum lying in the building position of an inner liner in the tire building process and the inner liner member 20A is joined at the winding initiating end portion 22 and the winding terminating end portion 23 of the spiral winding which are superposed on each other on the building drum with them acting as the joint margins.

As this occurs, as is shown in FIGS. 8 and 9, the amount in which both the end portions 22, 23, which act as the joint margins, are superposed can be adjusted as required at the joint portion where both the end portions 22, 23 are joined together. Consequently, by forming the joint margins each made up of at least one circumferential rotation of the rubber strip 21 at the winding initiating side end portion 22 and the winding terminating side end portion 23 by appropriately setting the strip width W1 of the rubber strip 21 and the pitch of the spiral winding, the joint is enabled where the rubber strip 21 is wound in two or more layers over the whole width.

Moreover, the cylindrical body 20 is cut on the line which connects the winding initiating end 21a with the winding terminating end 21b of the spiral winding of the rubber strip 21, the winding initiating side end portion 22 and the winding terminating side end portion 23, which make up the joint margins, are allowed to lie parallel throughout the full width, whereby both the end portions 22, 23 can joined together substantially uniformly and securely in such a state that both the end portions 22, 23 are superposed on each other.

In addition, since the strip pieces 21A which are cut in the way described above are such that the strip pieces 21A are spirally wound in such a manner as to be inclined to some extent relative to the circumferential direction and are then cut in the width direction, the strip pieces 21A are aligned at substantially right angles or close to right angles to the circumferential direction and are aligned in the same direction as that of the ply cords in the carcass layer which is affixed and laminated thereon, that is, are basically aligned in the same direction as the cords aligned in the radial direction. Due to this, since the direction of the strip pieces 21A becomes identical relative to the elongation of the tire in the radial direction thereof and the divergence of the cords in the circumferential direction and portions where a difference in level is caused by the overlap of the strip pieces 21A and irregularities caused by the ply cords does not cross each other, no air reservoir is produced, thereby making it possible to suppress the generation of a building failure and product failure.

In building a tire, the inner liner member 20A is affixed to the building drum in the way that has been described above so as to build an inner liner, thereafter, in ways similar to the conventional ones, rubber members such as chafer, squeegee and the like and furthermore carcass plies are affixed and laminated on the inner liner so as to build carcass bands. Thereafter, after beads are set and the carcass plies are turned up, rubber members such as belt layers, tread rubber, side walls and the like are affixed and laminated, so as to build a green tire which has not yet been vulcanized. Then, by vulcanizing the green tire so produced, a tire can be obtained which is configured as is shown in FIG. 10.

In the tire obtained in the way described above, since the inner liner configured by the use of the inner liner member 20A is such that the large number of strip pieces 21A are aligned at constant pitch and are joined together while being overlapped on each other and the end portions are joined together in two or more layers at the joint portion, a good weight balance is imparted to the tire, the uniformity of the tire is deteriorated in no case, and a separation or the like is produced in no case.

In addition, since the direction of the cut strip pieces 21A and the direction of the cord in the carcass layer are aligned substantially at the same angle and in the same direction, air reservoirs due to irregularities are produced in no case, and hence there is no fear that a building failure is caused. In addition, since the joint is provided in the only one location on the building drum which can be expanded and contracted, there is no fear that a bonding failure is caused.

Note that the inner liner member which is obtained by the invention can be applied not only to the tire in which the ply cords in the carcass layer which is laminated thereon are aligned substantially in the radial direction but also to a tire in which the ply cords in the carcass layer are inclined at least partially relative to the tire circumferential direction, for example, a tire in which a radial-ply region where the cords are aligned in the radial direction, that is, substantially at right angles (90°±10° to the tire circumferential direction and a bias-ply region where the cords are aligned oblique at an angle of 10 to 60° relative to the tire circumferential direction are mixed together.

### INDUSTRIAL APPLICABILITY

The invention can preferably be applied to a method and apparatus for producing inner liner members for tires and more particularly to the production of radial tires.

### BRIEF DESCRIPTION OF THE DRAWINGS

FIG. 1 A plan view which schematically shows a liner forming drum and a severing cutter which are used in carrying out an inner liner member producing method of the invention.

FIG. 2 A sectional view which schematically shows the same drum and cutter.

FIG. 3 A plan view which schematically shows a layout example of an apparatus which includes the same drum and cutter.

FIG. 4 A plan view which schematically shows a state in which a ribbon-shaped rubber strip is wound spirally.

FIG. 5 A sectional view which schematically shows the same state.

FIG. 6 A plan view showing a state in which a cylindrical body formed on the drum is cut so as to be place on a supporting table.

FIG. 7 A sectional view showing the same state with part thereof omitted.

FIG. 8 A sectioned explanatory view showing a joined state on a building drum.

FIG. 9 An explanatory view showing a joined state on the building drum.

FIG. 10 A sectional view showing the construction of a tire.

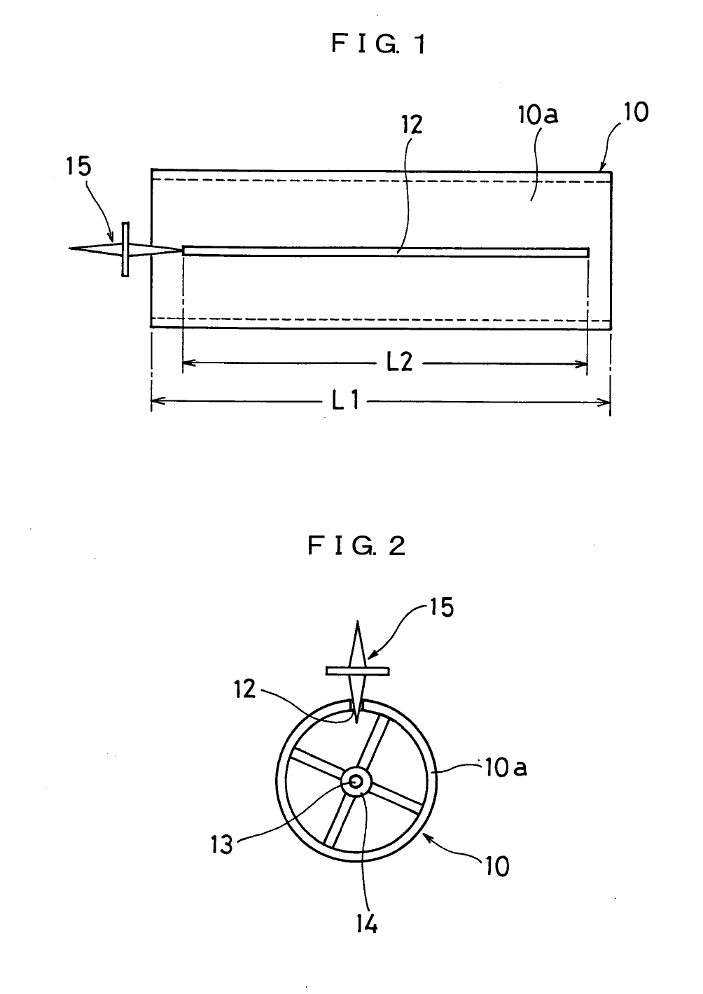

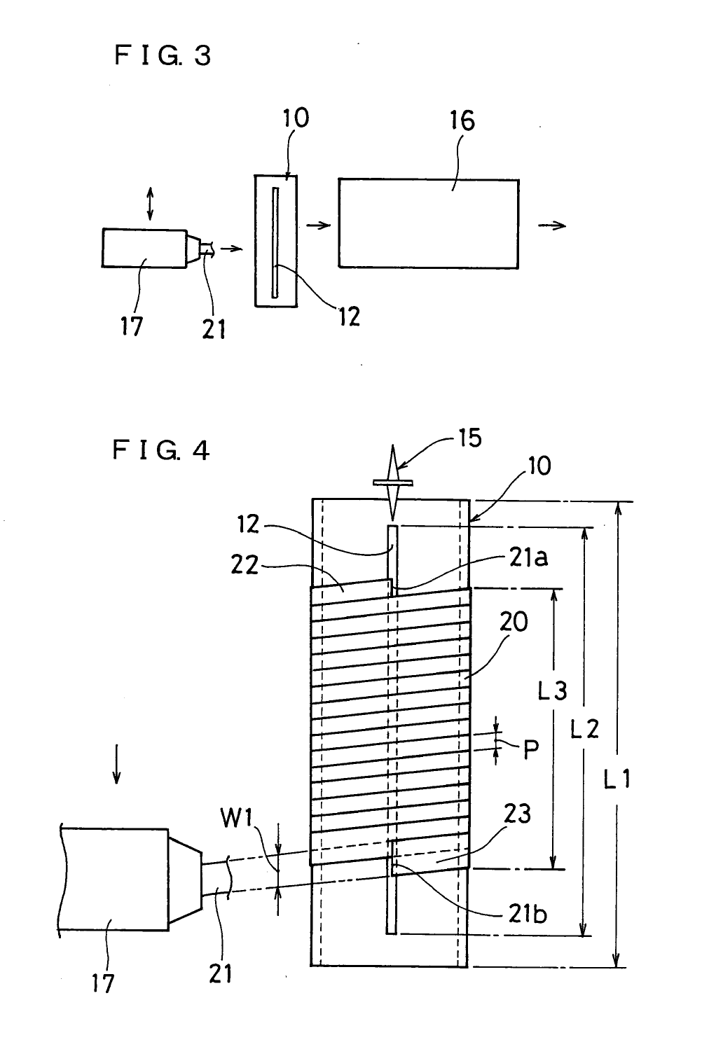

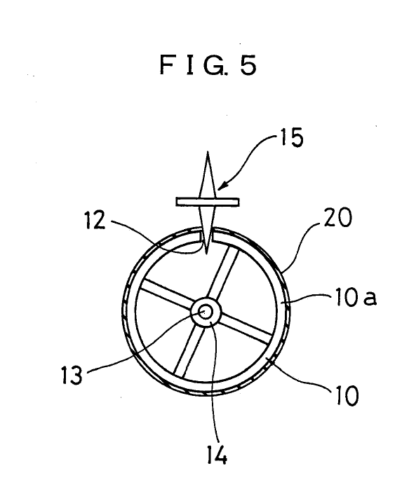

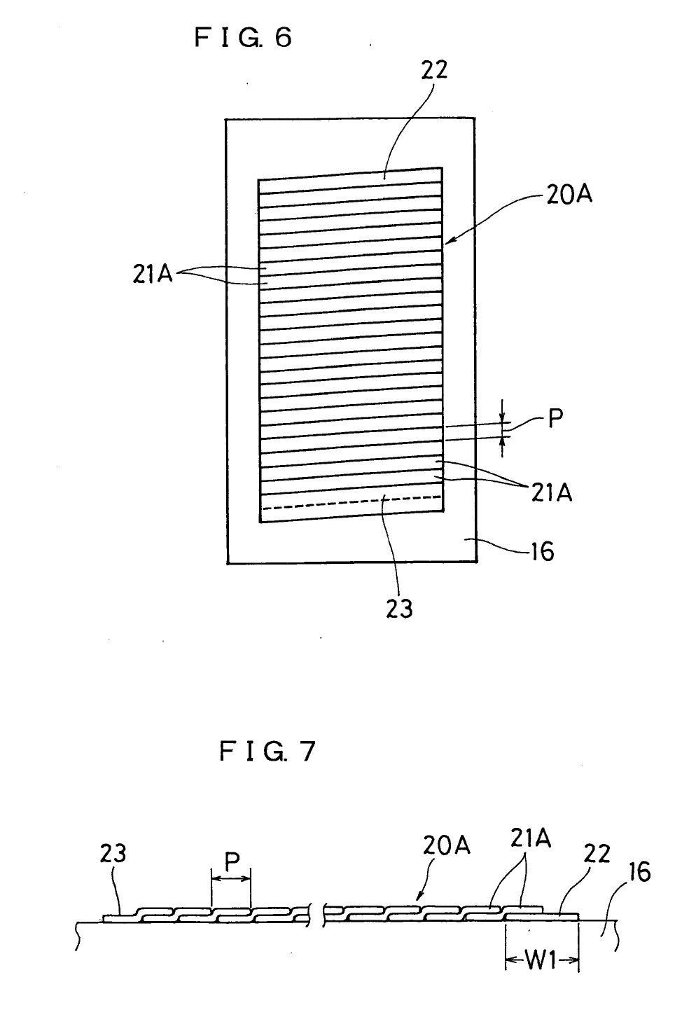

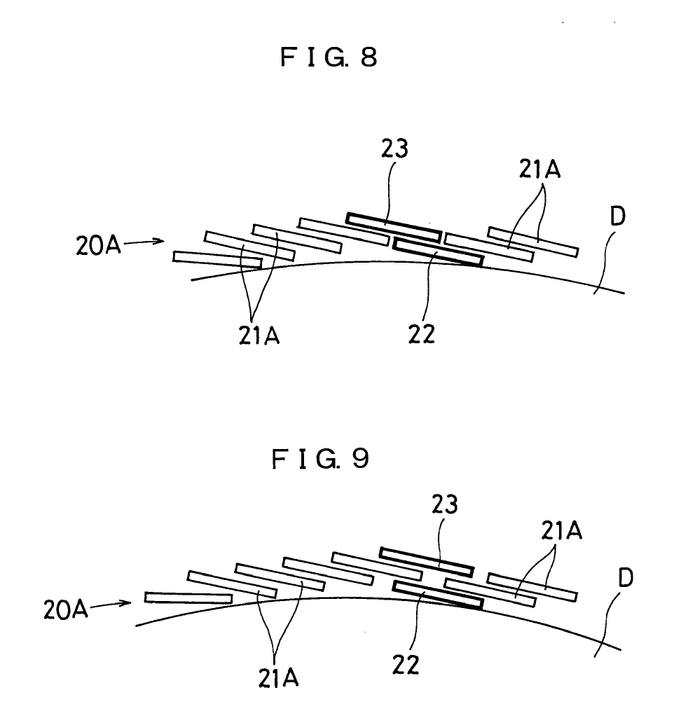

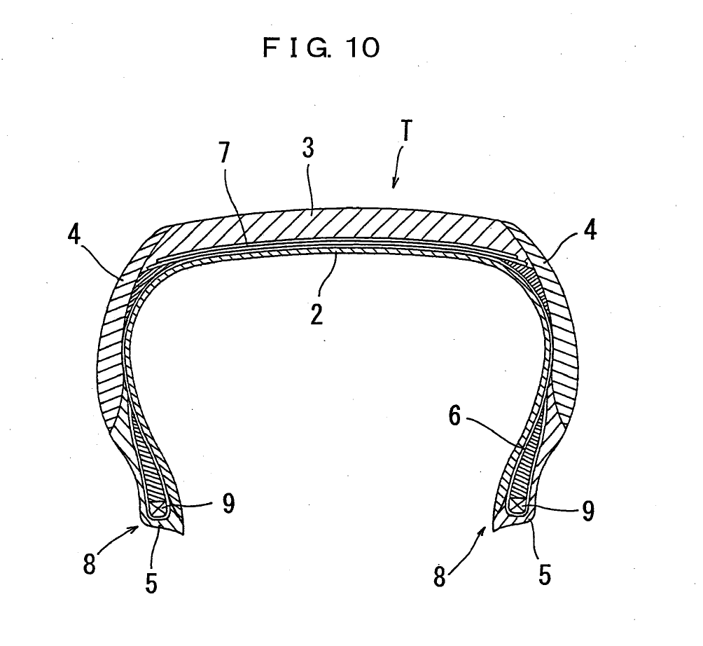

### DESCRIPTION OF REFERENCE NUMERALS AND CHARACTERS

tire; 2 inner liner; 3 tread; 4 side wall; 5 rim strip; 6 carcass layer; 7 belt layer; 8 bead portion; 9 bead core; 10 drum; 12 slit; 13 rotational support shaft; 14 boss portion; 15 severing cutter; 16 supporting table; 17 extruding machine; 20 cylindrical body; 20A inner liner member; 21 rubber strip; 21A cut strip pieces; 22 winding initiating side end portion; winding terminating side end portion; 21a winding initiating end; 21b winding terminating end; pitch of spiral winding; L1 axial length of the drum; L2 length of the slit; L3 axial length of the cylindrical body; W1 strip width; D building drum.

1. A tire inner liner member producing method characterized by comprising spirally winding a ribbon-shaped rubber strip round a liner forming drum at constant pitch in such a manner as to allow the rubber strip to partially overlap itself so as to be formed into a cylindrical body, and cutting the cylindrical body in a width direction which is parallel to a drum axial center in one location in a circumferential direction thereof, to thereby form the cylindrical body into the shape of a sheet in which strip pieces so cut are joined together in such a state that the strip pieces are aligned parallel to thereby give the cylindrical body a length corresponding to a liner circumferential length and in which both an end portion on a winding initiating side and an end portion on a winding terminating side of the spiral winding can be joined together on a building drum in a tire building process.

2. A tire inner liner member producing method as set forth in claim 1, characterized in that the cylindrical body formed by spirally winding the rubber strip is formed such that a circumferential length thereof corresponds to a lateral width of an inner liner member on the building drum and an axial length thereof corresponds to a length which results by adding joint margins to the liner circumferential length on the building drum and the cylindrical body so formed is then cut in the width direction which is parallel to the drum axial center so as to be formed into the shape of a sheet.

3. A tire inner liner member producing method as set forth in claim 1 or 2, characterized in that the rubber strip is wound spirally into the cylindrical body in such a manner that a winding initiating end and a winding terminating end of the rubber strip are aligned in positions on a line in the width direction which is parallel to the drum axial center and the cylindrical body is cut on the line which connects the winding initiating end and the winding terminating end.

4. A tire inner liner member producing method as set forth in claim 1 or 2, characterized in that the ribbon-shaped rubber strip is wound spirally in such a manner as to be overlapped on itself one half or more of a strip width, so that the rubber strip is wound in two or more layers except for both the winding initiating side end portion and the winding terminating side end portion thereof.

5. A tire inner liner member producing apparatus characterized by comprising a liner forming drum which is a cylindrical drum which has an axial length which is longer than a tire circumferential length of an inner liner member that is to be produced and a circumferential length which corresponds to a lateral width of the inner liner member and in which a cutting slit which is longer than the tire circumferential length of the inner liner member is formed in one location in a circumferential direction thereof and a severing cutter whose edge is adapted to enter the slit in the drum, so that a cylindrical body made up of a rubber strip which is wound spirally round the drum can be cut along the slit.

6. A tire inner liner member producing apparatus as set forth in claim 5, characterized by comprising a supporting table on which a sheet-shaped member which results after the cylindrical body is cut is to be placed.

7. A tire having an inner liner in an innermost layer, characterized in that a sheet-shaped inner liner member, which is obtained by a producing method as set forth in claim 1 or 2 and in which a large number of cut strip pieces are aligned to be joined in parallel with each other as a result of a cylindrical body made up of a ribbon-shaped rubber strip which is wound spirally in such a manner as to be partially overlapped on itself being cut in a width direction which is parallel to a drum axial center in one location in a circumferential direction thereof, is joined together at winding initiating side and winding terminating side end portions of the spiral winding where the rubber strip is superposed in two or more layers.

8. A tire as set forth in claim 7, the strip pieces which make up the inner liner are aligned in the same direction as that in which ply cords are aligned in a carcass layer which is laminated thereon.

9. A tire having an inner liner in an innermost layer, characterized in that a sheet-shaped inner liner member, which is obtained by a producing method as set forth in claim 3 and in which a large number of cut strip pieces are aligned to be joined in parallel with each other as a result of a cylindrical body made up of a ribbon-shaped rubber strip which is wound spirally in such a manner as to be partially overlapped on itself being cut in a width direction which is parallel to a drum axial center in one location in a circumferential direction thereof, is joined together at winding initiating side and winding terminating side end portions of the spiral winding where the rubber strip is superposed in two or more layers.

10. A tire having an inner liner in an innermost layer, characterized in that a sheet-shaped inner liner member, which is obtained by a producing method as set forth in claim 4 and in which a large number of cut strip pieces are aligned to be joined in parallel with each other as a result of a cylindrical body made up of a ribbon-shaped rubber strip which is wound spirally in such a manner as to be partially overlapped on itself being cut in a width direction which is parallel to a drum axial center in one location in a circumferential direction thereof, is joined together at winding initiating side and winding terminating side end portions of the spiral winding where the rubber strip is superposed in two or more layers.

11. A tire as set forth in claim 9, the strip pieces which make up the inner liner are aligned in the same direction as that in which ply cords are aligned in a carcass layer which is laminated thereon.

12. A tire as set forth in claim 10, the strip pieces which make up the inner liner are aligned in the same direction as that in which ply cords are aligned in a carcass layer which is laminated thereon.
